(19) United States
(12) Patent Application Publication
(10) Pub. No.: US 2006/0009948 A1
(43) Pub. Date: Jan. 12, 2006

(54) Method and apparatus for inspecting parts with high frequency linear array

(76) Inventors: Dannis Wulf, Tulsa, OK (US); Larry Busse, Fort Mitchell, KY (US)

Correspondence Address: DOERNER, SAUNDERS, DANIEL & ANDERSON, 320 SOUTH BOSTON, SUITE 500, TULSA, OK, 74103, US

(21) Appl. No.: 10/947,561

(22) Filed: Sep. 22, 2004

Related U.S. Application Data
(60) Provisional application No. 60/509,016, filed on Oct. 4, 2003.

(51) Int. Cl. G06F 15/00

(52) U.S. Cl. 702/159

(57) ABSTRACT

An apparatus and method for a nondestructive examination of an aircraft or other metal or composite object. The apparatus for a nondestructive examination includes a linear array of ultrasound transducer, a wedge used to provide an interface between the linear array and the object being examined wherein the angle of the wedge is determined by use of Snell's law wherein the signals from the linear array are manipulated by a micro computer which then presents a visual display of the object being examined and any flaws found in the object.

### REFERENCE TO RELATED APPLICATIONS

This application claims priority of U.S. provisional patent application Ser. No. 60/509,016, entitled “Method and Apparatus for Inspecting Parts with High Frequency Linear Array,” by Dennis Wulf and Larry Busse, and having a filing date of Oct. 4, 2003, the description of which is incorporated herein by reference.

### TECHNICAL FIELD OF THE INVENTION

The present invention relates to the field of ultrasound technology. More specifically, it is directed toward a method and apparatus for nondestructive testing and inspection of metal and composite parts with an ultrasound high-frequency linear array. Such parts are typically found on aircraft, although the apparatus and method can be used on other types of parts where a visual inspection would not provide a complete disclosure of the condition of the part.

### BACKGROUND OF THE INVENTION

Nondestructive testing has become an important tool in many industries today in order to evaluate the structural integrity of solid parts and parts that otherwise could not be tested without being destroyed. One such application is the inspection of aircraft airframes. The most prevalent form of nondestructive testing for aircraft is a visual inspection. The problem with visual inspection is that only the outer surface of the aircraft can be checked for corrosion and fatigue cracking. Much of the corrosion and cracking which can adversely affect the strength of the airframe occurs on surfaces which are not viewable without disassembly of the aircraft.

One of the most common ways to perform non-destructive testing on metal joints in the aircraft industry is through the use of eddy currents. This typically involves the use of a coil through which an electric current is sent. This produces a magnetic field which is passed over the surface of the joint. Sensors are also passed over the joint along with the coil to sense the differences in the eddy currents or magnetic field. If there is a void or defect present in the joint, the sensors will pick up a change in the eddy currents. The operator of the system then monitors the output in the form of a graph or a dial with a needle indicating the output.

One of the technologies that has been used to overcome the shortcomings of a visual inspection is that of ultrasonic, nondestructive evaluation. U.S. Pat. No. 4,301,684 issued to Robert B. Thompson, et al., on Nov. 24, 1981, discloses a method for evaluating the structural integrity of an object, including the steps of generating a lowest quarter horizontal shearwave in the object, detecting the wave after it has propagated through the object, time gating the detected signal to reject non-useful portions, Fourier transforming the time response of the detected signal into a frequency-dependent response, and predicting the structural integrity of the object from the characteristics of the frequency response. One of the drawbacks of this type of inspection is that the output from this prior art system were limited to a graph. This graph then had to be interpreted to locate the presence of any voids or other defects.

The development of ultrasound technology in the medical field has made great strides forward in the last few years. Doctors routinely use ultrasound to diagnose cardiovascular problems as well as identifying prenatal defects of in vitro fetuses. Expectant mothers routinely receive ultrasound examinations.

The ultrasound systems developed for use in the medical field have made great advances in the imaging that is available, especially in comparison to that which is available from the ultrasound systems used for nondestructive testing and examination and other industries, such as the aerospace industry.

Computer technology has also advanced along with ultrasound technology such that small inexpensive ultrasound systems are now available in the medical industry which can be used for medical examination and diagnostics. Heretofore, the ultrasound systems used in the medical field had been prohibitively expensive and did not contain the ability to be reprogrammed for use in other fields.

### BRIEF SUMMARY OF THE INVENTION

The present invention incorporates using certain ultrasound systems which are readily available in the medical field. These systems can then be reprogrammed so that the system is set for the speed of sound going through the metal, composite or other material being examined instead of the speed of sound going through water as it is commonly set for use in the medical field.

The present invention includes a wedge typically made out of plastic or other known material to provide an interface in between a linear array and the object being examined. The angle of the wedge is determined by Snell's law. The ultrasound signal is sent into the plastic wedge as a longitudinal wave. At the interface between the wedge and the part being examined, these waves are mode converted into shear waves which then propagate into the part being examined. These waves are reflected and scattered by geometrical features and defects. The reflected waves are then transmitted back to the linear array where it is converted into an electrical signal which is then transmitted to an imaging system which interprets the signals and generates a visual display of the part including any defects.

The output of a visual display provides a much easier way to view the defects in a solid metal part without having to resort to interpreting a graph.

### DESCRIPTION OF THE DRAWINGS

FIG. 1 shows an example of the way in which the high frequency linear array can be used to inspect thin metal parts

FIG. 2 shows a more detailed view of the relationship of the array elements, wedge, and metal surfaces.

FIG. 3 shows an example of using the inspection device.

FIG. 4 shows a visualization of fatigue cracks at a rivet hole in a slat taken from an aircraft wing.

### DETAILED DESCRIPTION OF THE PREFERRED EMBODIMENT

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specifications describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

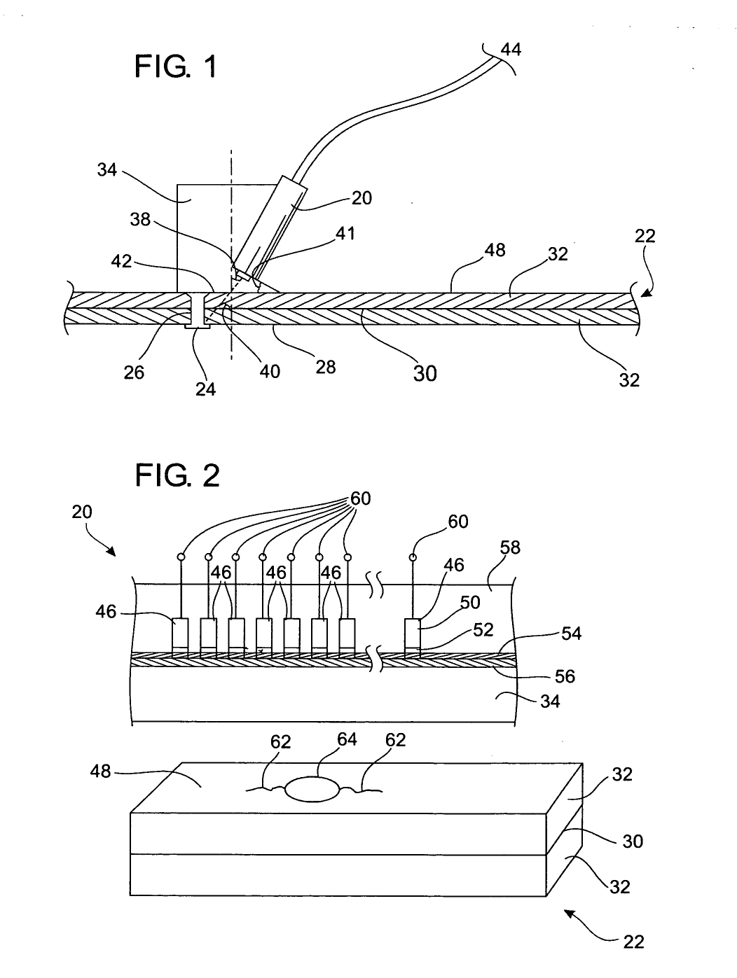

FIG. 1 shows an example of the way in which the high frequency linear array 20 can be used to inspect parts. In this case the parts 22 are two pieces of sheet metal joined using a fastener 24. In this case, the fastener 24 is a rivet, although other types of fasteners 24 and/or joints can be inspected using the present invention. The fastener 24 (and the hole 26 through which it passes) tend to be the site where stress cracks are initiated in the parts 22. With wear and exposure to moisture, the area around the fastener 24 can also become corroded. This corrosion can also take place in the far surface 28 of the part 22 or in the surfaces 30 between the pieces 32.

To perform the inspection, the linear array 20 is mounted on a wedge 34. The wedge 34 can be made from any dense material that transmits ultrasound waves well. In the preferred embodiment, it is made of plastic. The angle of the wedge 36 is chosen using Snell's law to generate shear ultrasonic waves in the metal parts. Snell's Law is expressed as:

$$\frac{Vp}{SIN ( θ p )} = \frac{Vm}{SIN ( θ m )}$$

where Vp is the speed of the ultrasound waves through the material of which wedge 34 is made. Vm is the speed of the ultrasound waves through the material of which the parts 22 are made. Θp 38 is the angle as indicated in FIG. 1 and Θm 40 is the angle as indicated in FIG. 1.

As can be seen in FIG. 1, the angle Θp 38 is equal to the angle of incline 41 of the wedge 34. In the preferred embodiment, the angle 41 of the wedge 34 is 22°, 31°, or 40°. This produces a shear wave which respectively is 30°, 45°, or 60°. It should be pointed out that while these angles are the preferred angles of the wedge, the invention could be used with any other wedge angle.

The array 20 launches compressional (longitudinal) waves into the wedge 34. At the wedge/part interface 42, these waves are mode-converted to shear waves which then propagate into the part 22. These waves are reflected and scattered by geometrical features and defects. The reflected waves follow a similar path back to the linear array 20 where the energy from the waves is converted to electrical signals which are then transmitted to the imaging system console 44 where an image is generated and displayed. It should be noted that inspections can also be performed using mode-converted longitudinal wave within the part 22.

The imaging system console 44 operates a group of adjacent array elements (4-32 elements) during any given transmit/receive cycle. The transmit pulses consist of short bursts (1-2 cycles) of high frequency (5-20 MHz center frequency) ultrasound. By applying time delays to these pulses during the transmit portion of the cycle, a focused transmit beam can be generated. By applying time delays during the receive portion of the cycle, a focused receive beam is formed. The receive beam is said to be dynamically focused because these receive time delays can be varied as the reflected signals are being collected; e.g., signals returning first are from the most shallow depths of the part 22 and they can be focused using delays which are different than signals returning at a later time from deeper regions of the part 22. A single image line is formed by converting the amplitude versus time receive signal into a brightness versus depth line on the console screen. A full image is formed by electronically stepping the active group of elements along the linear array 20, thereby generating a sequence of image lines. Images are generated very quickly and a rate of 30 frames per second or faster. Motion of the linear array 20 and wedge 34 allows a sequence of images to be displayed in real-time on the display of the imaging system console 44. The images can also be analyzed using software to monitor and record when echoes in a certain “region-of-interest” (ROI) in the image exceed a predefined threshold (signal level).

Images can be displayed in color or gray-scale. The brightness and color of individual pixels in the image is determined by a look-up-tables (LUTs) in the imaging system console 44 which are used to convert from signal level to image brightness or color.

FIG. 2 shows a more detailed view of the relationship of the array elements 46, wedge 34, and the surfaces of the part. The array is comprised of many (128 or more) individual elements. Each array element 46 consists of a piezoelectric material 50 (e.g. Lead Zirconate Titanate (aka PZT)) bonded to two matching layers 52 and 54 and protected on the front surface by a silicone rubber sheet 56. The group of array elements 46 is potted in a sound absorbing backing material. Individual electrical connections are made to each array element 46 using miniature coaxial cable, or a patterned flexible circuit or a combination thereof. The line in which the array elements 46 lie and the normal to that line determine the image plane within the wedge 34. The plane is bent (according to Snell's Law) as it enters the part 22.

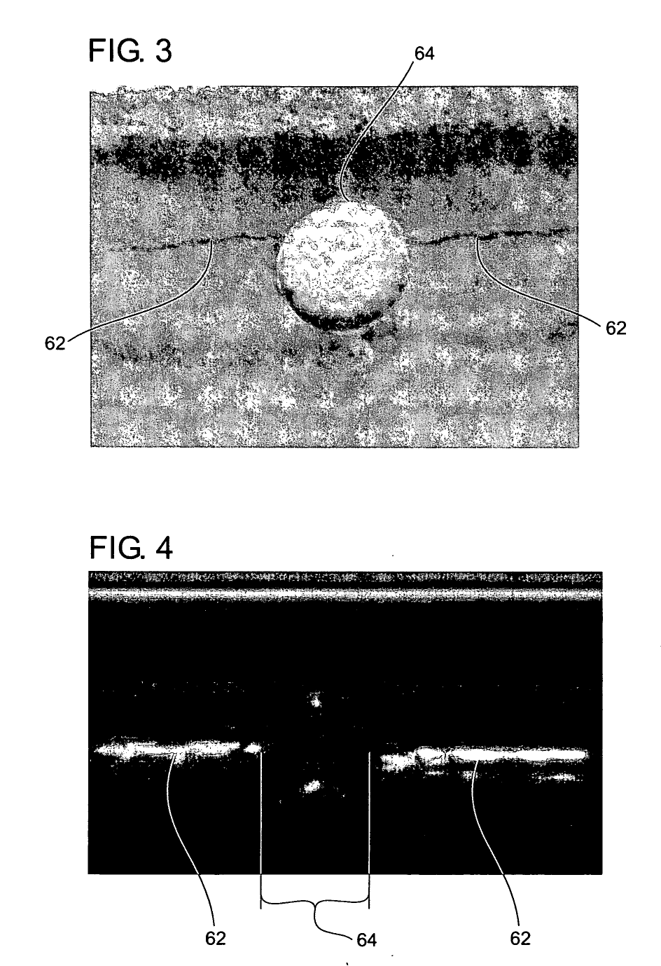

FIG. 3 shows an example of using the inspection device and method to visualize fatigue cracks 62 at a rivet hole 64 in a slat taken from an aircraft wing. The image in FIG. 3 shows an optical picture of the rivet hole 64 (0.xx″ diameter) and associated cracks 62. The image in FIG. 4 shows the ultrasound image obtained using 45 degree shear wave inspection technique. The edges of the rivet hole 64 and associated cracks 62 are indicated by the white arrows. The overall length of the two cracks 62 is ˜0.8″ and the overall width of the image is ˜1.2″ which corresponds to the physical width of the linear array 20.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

| | |
|---|---|
| 20 | linear array |
| 22 | parts |
| 24 | fastener |
| 26 | hole |
| 28 | far surface |
| 30 | surface (between pieces of part) |
| 32 | pieces (of part) |
| 34 | wedge |
| 36 | angle of the wedge |
| 38 | [symbol] p |
| 40 | [symbol] m |
| 41 | incline angle of the wedge |
| 42 | wedge/part interface |
| 44 | imaging system console |
| 46 | array elements |
| 48 | top surface (of part) |
| 50 | PZT |
| 52 | matching layer 1 |
| 54 | matching layer 2 |
| 56 | silicone rubber sheet |
| 58 | backing material |
| 60 | electrical connections |
| 62 | fatigue cracks |
| 64 | rivet hole |
| 66 | edges (of the rivet hole) |
| 68 | crack |

What is claimed is:

1. A method for nondestructive inspection comprising:
placing a wedge of ultrasonic conducting material on an object to be inspected;
using a linear array to send a longitudinal ultrasonic wave through the wedge and into the object;
receiving a return echo of the ultrasonic wave;
interpreting the return echo;
generating a visual representation of the joint; and
displaying the visual representation.

2. The method of claim 1, wherein the longitudinal ultrasonic waves are converted into shear ultrasonic waves upon entering the object to be inspected and converted back to longitudinal ultrasonic waves when reentering the wedge.

3. The method of claim 2, wherein the wedge has an angle, the angle being selected in accordance with Snell's Law to produce a desired angle of the shear ultrasonic waves.

4. The method of claim 1, wherein the ultrasonic waves are sent in short bursts.

5. The method of claim 4, wherein the bursts are less than 3 cycles.

6. The method of claim 1, wherein the ultrasonic waves have a frequency of 5 to 20 MHz.

7. The method of claim 6, wherein the ultrasonic waves have a frequency of 5 MHz.

8. The method of claim 6, wherein the ultrasonic waves have a frequency of 7 MHz.

9. The method of claim 6, wherein the ultrasonic waves have a frequency of 9 MHz.

10. The method of claim 6, wherein the ultrasonic waves have a frequency of 12 MHz.

11. The method of claim 6, wherein the ultrasonic waves have a frequency of 15 MHz.

12. The method of claim 1, wherein the wedge has an angle of 22°

13. The method of claim 1, wherein the wedge has an angle of 31°.

14. The method of claim 1, wherein the wedge has an angle of 40°.

15. The method of claim 1, wherein the wedge is made of plastic.

16. The method of claim 1, further comprising placing a gel between the wedge and the object to be inspected.

17. The method of claim 1, further comprising placing a gel between the linear array and the wedge.

18. The method of claim 1, wherein the visual representation is comprised of colored elements generated from a look up table based on a condition of the object to be inspected.

19. The method of claim 1, further comprising focusing the ultrasonic waves by varying a time delay of receiving the return echo.

20. The method of claim 4, further comprising focusing the ultrasonic waves by varying a time delay of the bursts.

21. The method of claim 20, further comprising focusing the ultrasonic waves by varying a time delay of receiving the return echo.

22. The method of claim 1, wherein the object to be inspected is comprised of a plurality of parts.

23. The method of claim 22, where the plurality of parts is held together by a fastener.
